(19) United States
(12) Patent Application Publication
(10) Pub. No.: US 2025/0036115 A1
(43) Pub. Date: Jan. 30, 2025

(54) COMPUTER SYSTEM AND METHOD FOR A LABORATORY INDEX

(71) Applicant: Kewaunee Scientific Corporation, Statesville, NC (US)

(72) Inventors: Jeremy MILLER, Statesville, NC (US); Kurt P. Rindoks, Statesville, NC (US); Abdul Rahman, Bengaluru (IN); Shine Chandran, Bengaluru (IN)

(21) Appl. No.: 18/781,016

(22) Filed: Jul. 23, 2024

Related U.S. Application Data
(60) Provisional application No. 63/528,480, filed on Jul. 24, 2023.

(51) Int. Cl. G05B 23/02; G05B 15/02

(52) U.S. Cl. CPC G05B 23/0254; G05B 15/02; G05B 23/0216; G05B 23/027; G05B 2219/2642

(57) ABSTRACT

A system for determining and using a laboratory index for a laboratory is provided. The system includes a plurality of laboratory devices. The system also includes a plurality of sensors configured to obtain sensor data regarding operation of the plurality of laboratory devices or conditions in the laboratory. Additionally, the system includes a terminal including a screen, at least one processor, and at least one memory device. The memory device(s) include computer readable code configured, when executed, to cause the processor(s) to receive the sensor data, calculate the laboratory index based on the sensor data, and cause a graphical user interface to be presented on the screen with one or more fields comprising data related to the laboratory index.

### CROSS-REFERENCE TO RELATED APPLICATION(S)

This application claims priority to U.S. provisional Patent Application No. 63/528,480, filed Jul. 24, 2023, entitled “Computer System and Method for a Laboratory Index,” which is hereby incorporated by reference in its entirety.

### FIELD

Embodiments relate generally to a computer-based system and method for assessing safety hazards and other conditions in a laboratory, and more particularly to a computer-based system and method for determining and displaying a laboratory index for use in a laboratory environment.

### BACKGROUND

Laboratories are critical facilities for scientific research and experimentation, but they can also present significant safety hazards if not managed correctly as laboratories are inherently risky environments. People that work in a laboratory are most likely under risk of exposure to hazardous substances including chemical, biological, and radioactive materials. Exposure to these and other things make laboratory areas hazardous environments.

Furthermore, reducing energy consumption in a laboratory is becoming more important as people are becoming aware of the need to achieve carbon neutrality. Approximately 60% to 80% of the energy consumption and utility costs in a laboratory stem from ventilated safety devices. Reducing the energy, by simply lowering air flow settings, may increase the risk that these devices fail to provide their typical performance levels.

Technology rich laboratory environments are improving to meet the challenge of historically fragmented and manual configurations and processes. However, building technologies supporting these mission-critical experiments are behind in design, integration, and connectivity. Additionally, building technology design in many life sciences facilities is fragmented, with critical systems like building management systems (BMS), access control, lighting controls, and energy management being designed and implemented in silos with their own software instances, monitoring platforms, and control programs.

### BRIEF SUMMARY

There is a need for a computer-based system and method to overcome the aforementioned technical problems and challenges. Without forethought to integrate technologies within a laboratory, data cannot flow between different devices and systems within a laboratory, leaving facility and operations teams without access to valuable data from these mission-critical systems.

Certain embodiments of the present invention generally to a system configured to collect data from multiple sources and to quantify and display a laboratory index based on this data, and associated methods are also provided. The laboratory index may be related to safety within the laboratory and may be a measure of risks based on an algorithm that processes values input by a user(s) of the system. Additionally or alternatively, the laboratory index may be related to comfort levels within the laboratory. The laboratory index may provide a comprehensive metric that indicates an accurate representation of the laboratory as a whole, or the laboratory index may provide a metric that is representative of the functioning of some aspect of the laboratory (e.g., condition of fume hoods, condition of HVAC systems, air quality, etc.).

Systems may be provided that are configured to identify safety issues based upon variable parameters which are important for maintaining safety in the laboratory. This differs from monitoring and alarming based on deviation from a parameter measurement. Various embodiments may enable systems to monitor parameters set by the user, thereby providing the user with freedom to adjust the operation of the systems based on the user's intended use of the laboratory, based on preferences, etc.

Various embodiments described herein aim to solve the aforementioned issues by providing a graphical user interface on a common display platform, with the graphical user interface presenting critical information regarding the laboratory index and other details regarding the operation of the laboratory in a common display platform. Information may be input from different components and locations and processed, and an overall score may be computed and output.

In some embodiments, the laboratory index may be created based upon real-time values for certain parameters related to the laboratory or equipment therein. Example systems and methods may perform compressive data analysis and may provide a laboratory index in real time for an individual laboratory, combined laboratories, or multiple laboratories. Example systems and methods may provide a real time assessment of risk in a form of a laboratory safety index to laboratory personnel in order to indicate the risks associate with their laboratories in an overall score or output.

By continuously monitoring and analyzing laboratory performance, systems described herein may enable the performance of laboratories to be optimized, may enable laboratories and equipment therein to remain in compliance with relevant regulations, and may ensure a safe and healthy working environment for laboratory personnel.

Various embodiments described herein may improve the safety in a laboratory by identifying when inputs fail to meet expectations and providing alerts to occupants when safety concerns are present and identified. Monitoring safety concerns on a real-time display assists in making safety a priority in the laboratory, reducing liability, preventing damage to equipment, and achieving regulatory conformance. Additionally, alerts may be generated in order to alert the user of potential actions that may be taken to improve efficiency of systems or to reduce energy consumption.

The systems and methods described herein may be used in a variety of laboratory settings including, but not limited to, chemical, biological and analytical laboratories. The systems and methods described herein may also be used by academic and research institutions, government agencies, and private sector organizations. Some potential applications of the laboratory index include, but are not limited to, real-time monitoring and management of laboratory safety and performance, evaluation of laboratory performance and/or compliance with regulatory guidelines, identification of areas of improvement and optimization of laboratory performance, comparison of performance across multiple laboratories or facilities, and report generations as required by regulations.

The computer system and method described in various embodiments herein provides a technological and automated solution to laboratory risk assessment and safety monitoring and risk notification. Embodiments described herein represent significant technological advancements related to laboratory optimization and safety. Systems and method provide various technological solutions.

The use of laboratory index may be beneficial to provide early warning signs of potential issues. For example, issues related to HVAC, indoor air quality and other parameters, may be detected early by using a laboratory index rather than by merely monitoring individual parameters. Existing systems often identified issues regarding only one parameter. For example, a temperature value read by a thermometer may indicate that the temperature exceeds a maximum value in these systems. However, the laboratory indexes may be based on a combination of different parameters, and tracking of the laboratory indexes may allow for earlier identification of issues within a laboratory in some embodiments. By detecting issues earlier, adjustments may be made within a laboratory by the systems or laboratory personnel to take preventative measures before a problem escalates. For example, preventative measures may be taken by automatically adjusting valves so that they are in an opened state or a closed state. Additionally or alternatively, preventative measures may be taken by closing sashes associated with laboratory devices (e.g., fume hoods), thereby sealing the internal contents of the laboratory devices. Other preventative measures may also be taken.

Embodiments described herein may also develop corrective actions that may be taken to improve the operation of a laboratory or the operation of laboratory devices within the laboratory. In some embodiments, the corrective action may be presented to the user as a recommendation, and the user may either accept or reject the recommendation. Alternatively, the corrective action may be automatically implemented in some embodiments. The corrective action may be taken to correct an issue within the laboratory (e.g., air quality outside of desired range), but the corrective action may also be taken to simply optimize the laboratory (e.g., to improve energy usage).

Various embodiments may also include a machine learning unit, which may be configured to deploy machine learning or artificial intelligence techniques to develop various types of models. The machine learning unit may be utilized to develop models to identify corrective actions, to identify issues within a laboratory, to calculate a laboratory index, or to determine if an alert should be generated. The machine learning unit may be configured to identify patterns, trends, or other insights that other existing systems would not be capable of identifying. Additionally, the machine learning unit may be configured to be continuously improved over time after deployed, with new data being used to train a model after it is deployed. As such, the continuous improvement of models allows for technological advantages over other algorithmic approaches that are more static and that fail to adapt over time. Use of the machine learning unit may enable the model to be improved or adapted based on changes in the world, the general environment, the laboratory, the users therein, the uses for the laboratory, etc. Thus, the machine learning unit may enable models to be formed that are more accurate as a result of this improved adaptability.

The ability to train the model using data from other laboratory devices in other laboratories may provide a large amount of training data, thereby allowing models to be determined with increased accuracy. Additionally, the data obtained from other laboratory devices in other laboratories may be aggregated and/or anonymized before being used to train any machine learning model.

Graphical user interfaces may provide a user-friendly dashboard for tracking laboratory performance, making it easy for laboratory personnel to evaluate performance, identify trends and track compliance with regulatory guidelines. The graphical user interfaces may also present detailed and complex information related to several different laboratory parameters on small display and may allow for users to select one or more fields within the graphical user interfaces to quickly navigate to a specific screen having the information that the user needs. By allowing users to more efficiently use the graphical user interfaces and to more quickly navigate to the screen having the information that the user needs, the user may actively use terminals for a smaller amount of time, thereby allowing for energy consumption by the terminals to be adjusted. In some embodiments, the brightness of terminals may be adjusted when the terminals are not actively being used, or the terminal may only be configured to present graphical user interfaces upon the user coming in close proximity to the terminal or touching the terminal.

In an example embodiment, a system is provided for determining and using a laboratory index for a laboratory. The system includes a plurality of laboratory devices, and the system also includes a plurality of sensors configured to obtain sensor data regarding operation of the plurality of laboratory devices or conditions in the laboratory. The system includes a terminal comprising a screen, at least one processor, and at least one memory device. The memory device(s) comprise computer readable code configured, when executed, to cause the processor(s) to receive the sensor data, calculate the laboratory index based on the sensor data, and cause a graphical user interface to be presented on the screen with one or more fields comprising data related to the laboratory index.

In some embodiments, the system may also include an intake unit configured to receive the sensor data from the plurality of sensors with the sensor data provided in a plurality of communication protocols. The intake unit may be configured to convert at least some of the sensor data to a common communication protocol so that all of the sensor data is provided in the common communication protocol.

In some embodiments, the plurality of laboratory devices may include at least one of a camera, a fume hood, an exhaust blower, a heater, a chiller, a pump, a valve, a laboratory display, a gas chamber or a gas valve, a HVAC filter, a scrubber pump, or a scrubber tank. Additionally, in some embodiments, the plurality of sensors may include at least one of a carbon dioxide sensor, an airflow sensor, a temperature sensor, a humidity sensor, a pressure sensor, an occupancy sensor, a volatile organic compound sensor, a water level sensor, a pH meter, energy usage sensors, or an air quality sensor.

In some embodiments, the computer readable code may be configured, when executed, to cause the processor(s) to determine a corrective action based on the laboratory index and either cause an indication to be presented on the graphical user interface that recommends taking the corrective action or causes the corrective action to be automatically taken. Furthermore, in some embodiments, the laboratory index may be focused on energy consumption in the laboratory, and the corrective action may provide more efficient energy consumption in the laboratory.

In some embodiments, the system also includes a machine learning unit. The machine learning unit may be configured to develop a model, the model may be configured to use the sensor data as an input to the model, and the model may be configured to provide an output in the form of the laboratory index, a corrective action, or an alert. In some embodiments, the machine learning unit may be configured to develop the model based on historical data regarding operation of one or more laboratory devices that are identical to the plurality of laboratory devices. Furthermore, in some embodiments, a laboratory device of the laboratory device(s) may be located in another laboratory.

In some embodiments, the terminal may be mounted in the laboratory. In some embodiments, the terminal may be a mobile device.

In some embodiments, the laboratory index may be calculated at least once every five minutes. In some embodiments, the laboratory index may be indicative of a safety level or a comfort level for the laboratory or a laboratory device.

In some embodiments, the computer readable code may be configured, when executed, to cause the processor(s) to generate an alert at the terminal upon the laboratory index falling outside of a range.

In some embodiments, the graphical user interface may be configured to present data related to the laboratory index over time. In some embodiments, the graphical user interface may be configured to present a comparison of the laboratory index relative to additional laboratory index(es) for other laboratories.

In another example embodiment, a method is provided for determining and using a laboratory index for a laboratory. The method includes receiving sensor data from a plurality of sensors regarding operation of laboratory devices within the laboratory or conditions in the laboratory, calculating a laboratory index based on the sensor data, and causing a graphical user interface to be presented on a screen of a terminal. The graphical user interface comprises one or more fields comprising data related to the laboratory index.

In some embodiments, the sensor data may be received from the plurality of sensors in a plurality of communication protocols, and at least some of the sensor data may be converted to a common communication protocol so that all of the sensor data used to calculate the laboratory index is provided in the common communication protocol. Furthermore, in some embodiments, the method may also include determining a corrective action based on the laboratory index and causing an indication to be presented on the graphical user interface that recommends taking the corrective action or causes the corrective action to be automatically taken. In some embodiments, the laboratory index may be determined using a machine learning model with the machine learning model configured to utilize the sensor data as input data.

Further areas of applicability of the present invention will become apparent from the detailed description provided hereinafter. It should be understood that the detailed description and specific examples, while indicating the preferred embodiments of the invention, are intended for purposes of illustration only and are not intended to limit the scope of the invention.

### BRIEF DESCRIPTION OF THE DRAWINGS

Reference will now be made to the accompanying drawings, which are not necessarily drawn to scale, and wherein:

FIG. 1 is a block diagram illustrating an example system for determining and using a laboratory index for a laboratory, in accordance with some embodiments discussed herein;

FIG. 2A illustrates an example graphical user interface that may be presented on a terminal with various fields included showing values for different parameters related to the operation of a laboratory, in accordance with some embodiments discussed herein;

FIG. 2B illustrates an example graphical user interface similar to the graphical user interface of FIG. 2A where a pop-up window is presented with an indication of a recommended corrective action, in accordance with some embodiments discussed herein;

FIG. 3 illustrates an example graphical user interface that may be presented on a terminal with various fields included showing laboratory index information for different labs over time, in accordance with some embodiments discussed herein;

FIG. 4 illustrates an example graphical user interface that may be presented on a terminal with various fields included showing values for different parameters related to HVAC systems within a laboratory, in accordance with some embodiments discussed herein;

FIG. 5 illustrates an example graphical user interface that may be presented on a terminal with a pictorial representation of a fume hood illustrated alongside indications of different parameters related to the operation of the fume hood, in accordance with some embodiments discussed herein;

FIG. 6 illustrates another example graphical user interface that may be presented on a terminal with various fields included showing values for different parameters and lab indexes related to the operation of a laboratory, in accordance with some embodiments discussed herein;

FIG. 7 illustrates a plot that may be presented with information regarding energy consumption within a laboratory over time, in accordance with some embodiments discussed herein;

FIG. 8A is a front view illustrating an example terminal having a graphical user interface presented on the screen of the terminal, in accordance with some embodiments discussed herein;

FIG. 8B is a front view illustrating an example multi-terminal device comprising five different terminals, with each terminal providing information for a different laboratory, in accordance with some embodiments discussed herein; and

FIG. 9 is a flow chart illustrating an example method for determining and using a laboratory index, in accordance with some embodiments discussed herein.

### DETAILED DESCRIPTION

Example embodiments now will be described more fully hereinafter with reference to the accompanying drawings, in which some, but not all embodiments are shown. Any connections or attachments may be direct or indirect connections or attachments unless specifically noted otherwise. The following description of the embodiments of the present invention is merely exemplary in nature and is in no way intended to limit the invention, its application, or uses. The following description is provided herein solely by way of example for purposes of providing an enabling disclosure of the invention, but does not limit the scope or substance of the invention.

Further, the term “or” as used in this disclosure and the appended claims is intended to mean an inclusive “or” rather than an exclusive “or.” That is, unless specified otherwise, or clear from the context, the phrase “X employs A or B” is intended to mean any of the natural inclusive permutations. That is, the phrase “X employs A or B” is satisfied by any of the following instances: X employs A; X employs B; or X employs both A and B. In addition, the articles “a” and “an” as used in this application and the appended claims should generally be construed to mean “one or more” unless specified otherwise or clear from the context to be directed to a singular form. Throughout the specification and claims, the following terms take at least the meanings explicitly associated herein, unless the context dictates otherwise. The meanings identified below do not necessarily limit the terms, but merely provide illustrative examples for the terms. The meaning of “a,” “an,” and “the” may include plural references, and the meaning of “in” may include “in,” “at,” and/or “on,” unless the context clearly indicates otherwise. The phrase “in one embodiment,” as used herein does not necessarily refer to the same embodiment, although it may.

As used herein, the terms “machine learning” or “machine learning model” are intended to mean the application of one or more software application techniques that process and analyze data to draw inferences from patterns in the data. Machine learning techniques can process and analyze data to enable computer systems to autonomously learn and improve their performance over time from the data, to automatically identify patterns, extract insights, and make informed decisions or predictions without explicit programming for each scenario. The machine learning techniques can include a variety of artificial intelligence (AI) and machine learning (ML) models or algorithms, including supervised learning techniques, unsupervised learning techniques, reinforcement learning techniques, knowledge-based learning techniques, natural-language-based learning techniques such as natural language generation, natural language processing (NLP) and named entity recognition (NER), deep learning techniques, and the like. The machine learning techniques are trained using training data. The training data may be used to modify and fine-tune any weights associated with the machine learning models, as well as record ground truth for where correct answers can be found within the data. As such, the better the training data, the more accurate and effective the machine learning model.

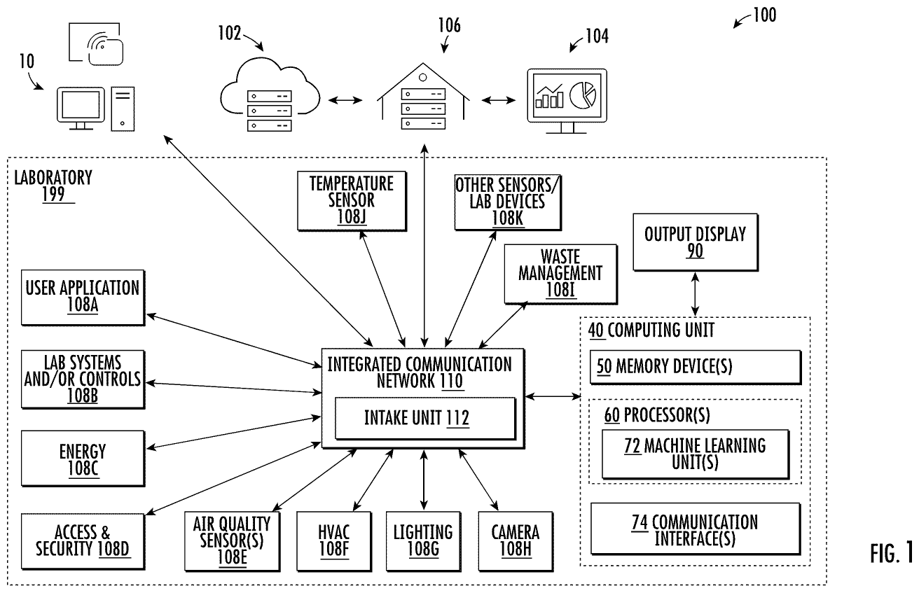

FIG. 1 illustrates a block diagram illustrating an example system 100 for determining and using a laboratory index for a laboratory. The system 100 may comprise hardware and software for use in determining a laboratory index and displaying the laboratory index.

The system 100 includes an integrated communication network 110. The integrated communication network 110 may facilitate connections between different components within the system 100. The system 100 also includes a user device 10 which may include a user interface. The user device 10 may be communicatively connected to the integrated communication network 110. The system 100 may be accessed by a user through the user device 10. For example, the system 100 may be accessed on the user device 10 through a website or link on the internet using a computer system or platform. The user device 10 may be provided in the form of a computer system or platform, a cell phone such as a smart phone, a tablet, or another device. However, the system 100 may be accessed using other components such as the reporting unit 104, the output display 90, the computing unit 40, or another component. A user may input data at the user device 10 to communicate over the integrated communication network 110 with the computing unit 40.

A computing unit 40 may also be provided in the system 100. The computing unit 40 may be provided in the form of one or more computers, one or more servers, one or more nodes within a network, or one or more other electronic devices. The computing unit may comprise one or more memory devices 50, one or more processors 60, and one or communication interfaces 74. The computing unit 40 and/or other devices may be configured to generate reports that may be required for regulatory compliance based on historical data for a laboratory. Other components in the system 100 may include memory device(s), processor(s), communications interface(s), similar to those included in the computing unit 40.

In an example embodiment, the memory devices 50 may include one or more non-transitory storage or memory devices such as, for example, volatile and/or non-volatile memory that may be either fixed or removable. The memory devices 50 may be configured to store instructions, computer program code, data, additional data in a non-transitory computer readable medium for use, such as by the processor(s) 60 for enabling the components of the system 100 to carry out various functions in accordance with example embodiments described herein. For example, the memory devices 50 may be configured to buffer input data for processing by the processor(s) 60. Additionally or alternatively, the memory devices 50 may be configured to store instructions for execution by the processor(s) 60. The memory devices 50 may include computer program code that is configured to, when executed, cause processor(s) 60 to perform various methods described herein. The memory devices 50 may serve as non-transitory computer readable mediums having stored thereon software instructions that, when executed by one or more processor(s) 60, cause methods described herein to be performed.

The processor(s) 60 may be provided with one or more modules therein, and the processor(s) 60 may be configured to identify and analyze data input by a user at a user device 10, data from various devices and sensors within the laboratory 199, and data from other sources 30.

The processor(s) 60 may be any means configured to execute various programmed operations or instructions stored in a memory device (e.g., memory devices 50) such as a device or circuitry operating in accordance with software or otherwise embodied in hardware or a combination of hardware and software (e.g. a processor operating under software control or the processor embodied as an application specific integrated circuit (ASIC) or field programmable gate array (FPGA) specifically configured to perform the operations described herein, or a combination thereof) thereby configuring the device or circuitry to perform the corresponding functions of the processor(s) 60 as described herein.

The processor(s) 60 may be configured to receive sensor data from the sensors or devices 108A-108K, and this sensor data may be received in a common communication protocol. However, in some embodiments, the sensor data may be provided to the processor(s) 60 in different communications protocols and the processor(s) 60 may be configured to cause the sensor data to be converted to a single common communication protocol. The processor(s) 60 may be configured to calculate the laboratory index based on the sensor data, and the processor(s) may be configured to cause a graphical user interface to be presented on a screen of the output display 90. The screen may include one or more fields comprising data related to the laboratory index.

The processor(s) 60 may include one or more machine learning units 72. The machine learning unit(s) 72 may use artificial intelligence or machine learning techniques to develop models. The machine learning unit 72 may be configured to develop a model. The model may be configured to use sensor data received from various sensors or devices 108A-108K within the laboratory. The model may be configured to provide the laboratory index as an output, but the model may be configured to provide a corrective action and/or an alert as an output instead of or in addition to the laboratory index. The machine learning unit 72 may be configured to develop the model based on historical data regarding the operation of laboratory device(s) that are similar to or identical to the laboratory devices in the laboratory. This historical data may be from laboratory devices in the user's laboratory or from laboratory devices located in a different laboratory. Where the historical data is from a different laboratory, this laboratory may be affiliated with the user or with another third-party. Where historical data is obtained from a laboratory of another third-party, then the historical data may be aggregated and/or anonymized before being used to form a machine learning model.

The communications interface(s) 74 may be configured to enable communication to other components of the system 100 or to external device(s). The communications interfaces 74 may also include one or more communications modules configured to communicate with one another in any of a number of different manners including, for example, via wired connections. However, communications interface(s) 74 may be configured to communicate with one another in other ways such as via a network (e.g., integrated communication network 110). In this regard, the communications interface(s) 74 may include any of a number of different communication backbones or frameworks including, for example, Ethernet, global positioning system (GPS), cellular, Wi-Fi, or other suitable networks. In some embodiments, some or all of the communications interface(s) 74, may be configured to communicate using short-range wireless technologies such as Bluetooth (e.g., Bluetooth Version 4.1 or another version), Wi-Fi, NearLink, near-field communication (NFC), low power wide area networks (LPWAN), ultra-wideband (UWB), wireless local area network (WLAN) in accordance with IEEE 802.11(b), IEEE 802.11(g), and/or IEEE 802.11(n) standards, and/or low-rate wireless personal access networks (LR-WPAN) pursuant to the IEEE 802.15.4 standard.

Modules and/or units disclosed herein can also refer to a processor, portions of a processor, computer program and/or the processor/special circuitry that implements that functionality. Elements, modules, units, and components described herein may be further divided into additional components or joined together to form fewer components for performing the same functions. Further, any of the functions disclosed herein may be implemented using means for performing those functions. Such means include, but are not limited to, any of the components disclosed herein, such as the electronic or computing device components described herein.

An output display 90 is connected to the computing unit 40. The output display 90 may include a user interface (e.g., a touch screen) configured to enable a user to input information to adjust the operation of the system 100. However, in other embodiments, the user may input information at other locations in the system 100 (e.g., at user device 10). While the output display 90 is illustrated as a separate component from the computing unit 40, the output display 90 may be integrated within the computing unit 40 in some embodiments. The computing unit 40 may be configured to cause certain graphical user interfaces to be presented on the output display 90 or at another display (e.g., at user device 10).

A data warehouse unit 106 may be connected to the integrated communication network 110. The data warehouse unit 106 may be provided in the form of one or more computers, one or more servers, one or more nodes within a network, or one or more other devices, and the data warehouse unit 106 may include one or more processors and one or more memory devices. The data warehouse unit 106 may be configured to receive data from the various components within the laboratory 199 and may provide a location where this data may be stored in a secure manner. Data within the data warehouse unit 106 may be encrypted to provide additional security. The data included in the data warehouse unit 106 may receive data from the laboratory 199 and other laboratories so that this data may be analyzed. The data from various laboratories may be aggregated and/or anonymized by the data warehouse unit 106 or another component. In some embodiments, the intake unit 112 may be configured to anonymize any data from the laboratory 199 before sending the data to the data warehouse unit 106.

The system 100 also includes a data analysis unit 102. The data analysis unit 102 may be provided in the form of one or more computers, one or more servers, one or more nodes within a network, or one or more other devices, and the data analysis unit 102 may include one or more processors and one or more memory devices. The data analysis unit 102 may be configured to analyze the data stored within the data warehouse unit 106 to identify common trends, acceptable ranges for sensor data or for certain laboratory indexes, and other information. Analysis performed at the data analysis unit 102 may be communicated to the reporting unit 104 where a back-end administrator may view trends and other details related to the various laboratories, and this information may be presented in an aggregated and anonymized form. Additionally or alternatively, analysis performed at the data analysis unit 102 may be communicated to the user device 10 or to components in the laboratory 199 such as the output display 90 or the computing unit 40.

The system 100 also includes a reporting unit 104. The reporting unit 104 may be provided in the form of one or more computers, one or more servers, one or more nodes within a network, or one or more other devices, and the reporting unit 104 may include one or more processors and one or more memory devices. The reporting unit 104 may be configured to present information in a graphical user interface to a back-end administrator so that the back-end administrator may view trends and other details related to the various laboratories. This information may be presented in an aggregated and anonymized form in some embodiments. In some embodiments, the reporting unit 104 may be used to assist with performing required reporting functions.

In some embodiments, the system may be configured to help maintain the laboratory and equipment therein in compliance with regulatory guidelines, contractual obligations, and other criteria. The alarms set by the system may be configured to warn a user or an administrator using the reporting unit 104 when the operation of certain devices may need to be adjusted to ensure compliance.

Various sensors and devices may be provided in the laboratory 199. For example, a user application 108A may be provided, and this user application 108A may be an internet of things application.

One or more laboratory systems and/or controls 108B may be provided in the system 100 within the laboratory 199. The laboratory system(s) and/or control(s) 108B may include various laboratory devices such as those described herein, components associated with these laboratory devices, and controls for locking and unlocking the laboratory or laboratory devices therein. Laboratory system(s) and/or control(s) 108B may also include a sash (e.g., a glass window) that may be selectively opened or closed to provide access to the internal contents of laboratory equipment, and the sash may be automatically opened or closed based on commands received from processor or other components within the system 100 (e.g., upon laboratory indexes moving outside of an allowable range, processor(s) may cause the sash to be moved to a closed state). Additionally or alternatively, the laboratory system(s) and/or control(s) 108B may also include valves or other control equipment that may be selectively opened or closed to allow fluids to flow within the system 100 (e.g., upon laboratory indexes moving outside of an allowable range, processor(s) may automatically cause valve(s) to move to an opened state or a closed state). One or more energy systems 108C may be provided in the system 100 within the laboratory 199. The energy system(s) 108C may comprise battery units, lights, electrical circuits and electrical components, cables, etc.

One or more access and security systems 108D may be provided in the system 100 within the laboratory 199. The access and security system(s) 108D may include one or more processors and one or more memory devices. The access and security system(s) 108D may also include one or more locks or other mechanisms that are configured to selectively provide access to the laboratory 199 generally, to specific devices within the laboratory 199, or to certain parts of devices within the laboratory 199. For example, the access and security system(s) 108D may be configured to selectively provide access to the inner contents of a fume hood or another chamber.

One or more air quality sensors 108E may also be provided in the system 100 within the laboratory 199. The air quality sensor(s) 108E may be configured to detect the presence or level of certain chemicals or other material.

The system 100 also includes one or more heating, ventilation, and air conditioning (HVAC) units 108F, with the HVAC unit(s) 108F being positioned in the laboratory 199. However, some of the HVAC units 108F may be positioned outside of the laboratory in some embodiments and may provide air into the laboratory. The HVAC units 108F may comprise a heater, a chiller, a pump, a valve, an HVAC filter, etc. The HVAC units 108F may play a vital role in maintaining a healthy and safe laboratory environment. Sensors may be provided within the HVAC units 108F that are configured to monitor parameters such as airflow, air exchange rates, and/or filter efficiency, providing early warning signs of potential HVAC issues.

One or more lighting units 108G may be provided in the system 100 within the laboratory 199. The lighting unit(s) 108G may be provided in the form of light bulbs connected to electrical circuits, and the lighting unit(s) 108G may include one or more processors and one or more memory devices in some embodiments. The lighting unit(s) 108G may be configured to control lighting for the laboratory 199 as a whole or for a particular device within the laboratory 199 (e.g., lighting within a fume hood or within another enclosed volume).

One or more cameras 108H may be provided in the system 100 within the laboratory 199. The camera(s) 108H may be configured to obtain video images or still images of the laboratory 199 or of a device within the laboratory 199.

One or more waste management units 1081 may be provided in the system 100 within the laboratory 199. The waste management unit(s) 1081 may include containers, valves, pumps, heat exchangers, and other devices that may be configured to facilitate the safe disposal of waste from within the laboratory 199. Waste may be provided in a form that is hazardous and that requires storage in particular conditions. For example, waste may need to be stored at a particular temperature, at a particular pressure, etc. The waste management unit(s) 1081 may include one or more sensors therein to detect relevant parameters such as temperature, pressure, humidity (e.g., relative humidity), etc.

One or more temperature sensors 108J may be provided in the system 100 within the laboratory 199. The temperature sensor(s) 108J may be configured to measure the temperature within the laboratory 199 or within a device within the laboratory 199. Some of the temperature sensor(s) may be provided in the form of a thermostat, but some of the temperature sensor(s) may be configured to measure the temperature within other devices within the laboratory 199 such as within fume hoods, within HVAC systems, etc.

Other sensors or laboratory devices 108K may also be included in the system 100 and connected to the integrated communication network 110. For example, other sensors may include a carbon dioxide sensor, an airflow sensor, a humidity sensor, a pressure sensor, an occupancy sensor, a volatile organic compound sensor, a water level sensor, a gas level sensor, a pH meter, energy usage sensors, sensors configured to detect the presence or amount of certain chemical(s), or other sensors. Other laboratory devices may include a fume hood, an exhaust blower, a heater, a chiller, a pump, a compressor, a valve, a laboratory display, a gas chamber or a gas valve, a HVAC filter, a scrubber pump, and/or a scrubber tank. Actual data may be imported from the other sources including, but not limited to, field devices, controllers, software program(s), open architecture data points (such as temperature and humidity controls), standard operating procedure (SOP) guidelines, Air Change Rate setpoints, or level of biosafety levels (BSL) safety and service and maintenance schedules, etc. While all sensors and laboratory devices are illustrated as being positioned within the laboratory 199, some sensors or laboratory devices may be positioned outside of the laboratory 199.

Volatile organic compound sensors and carbon dioxide sensors may be configured to detect excessive levels of volatile organic compounds and carbon dioxide within the laboratory or within laboratory equipment. Excessive levels of volatile organic compounds and/or carbon dioxide may impact indoor air quality and may pose safety risks to laboratory personnel. Continuous monitoring for levels of volatile organic compounds and carbon dioxide may improve air quality and safety within laboratories.

An intake unit 112 is also provided in the system 100. The intake unit 112 may be provided in the form of one or more computers, one or more servers, one or more nodes within a network, or one or more other devices, and the intake unit 112 may include one or more processors and one or more memory devices. Alternatively, the intake unit 112 may be provided in the form of a processor, portions of a processor, computer program and/or the processor/special circuitry that implements that functionality. The intake unit 112 is included as part of the integrated communication network 110, but the intake unit 112 may be provided separately from the integrated communication network 110 in other embodiments. The intake unit 112 may be configured to receive the sensor data from the sensors 108A-108K. When the intake unit 112 initially receives this sensor data, the sensor data may be provided in several different communication protocols. For example, some sensor data may be provided in a MODBUS communication protocol while other sensor data may be provided in a BACnet communication protocol. Sensor data may be provided in other communication protocols as well. The intake unit 112 may be configured to convert at least some of the sensor data to a common communication protocol so that all of the sensor data is provided in the common communication protocol. The integrated communication network 110 may connect the components within the laboratory 199 to other external components, and the integrated communication network 110 may extend outside of the laboratory 199 to connect to devices in other laboratories and devices at other locations.

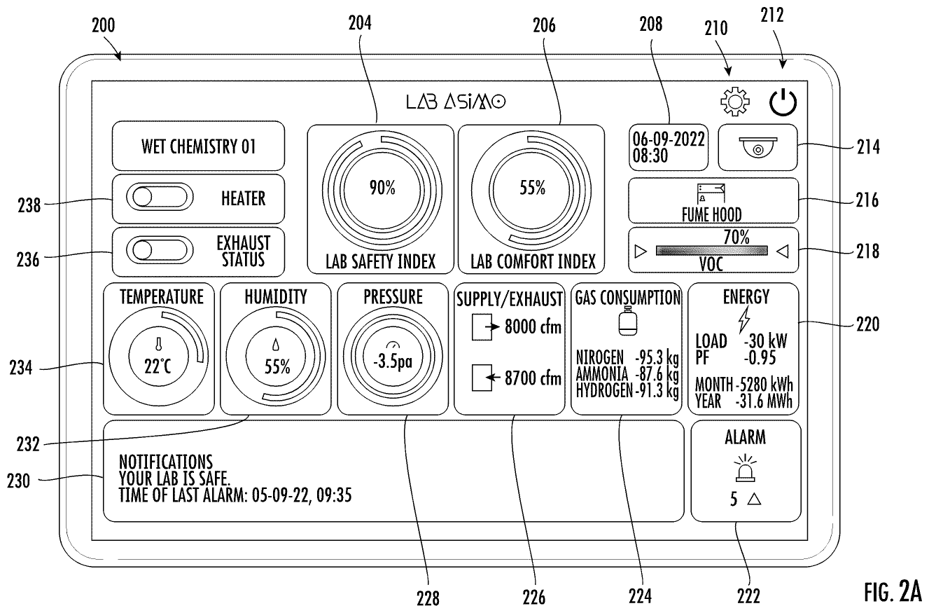

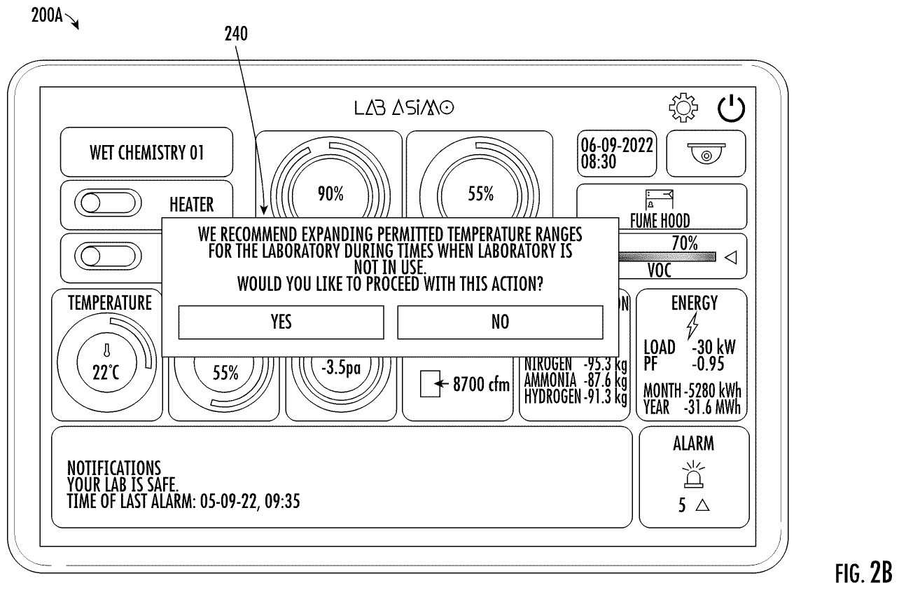

FIG. 2 illustrates an example graphical user interface 200 that may be presented on a terminal with various fields included showing values for different parameters related to the operation of a laboratory. The graphical user interface 200 and other graphical user interfaces 200 described herein may be configured to provide specific configurations depending on the particular user or laboratory group in some embodiments, with different fields being presented or with fields being arranged differently depending on the particular user or the particular laboratory group. However, this may not be the case in other embodiments.

The graphical user interface 200 and other graphical user interfaces may provide a user-friendly dashboard for tracking laboratory performance, making it easy for laboratory personnel to evaluate performance, identify issues, identify trends, and track compliance with regulatory guidelines. The graphical user interface 200 and other graphical user interfaces described herein may also present detailed and complex information related to several different laboratory parameters on small display and may allow for users to select one or more fields within the graphical user interfaces to quickly navigate to a specific screen having the information that the user needs. By allowing users to more efficiently use the graphical user interfaces and to more quickly navigate to the screen having the information that the user needs, the user may actively use terminals for a smaller amount of time, thereby allowing for energy consumption by the terminals to be adjusted. In some embodiments, the brightness of terminals may be adjusted when the terminals are not actively being used, or the terminal may only be configured to present the graphical user interface upon the user coming in close proximity to the terminal or touching the terminal.

The graphical user interface 200 may be presented on a terminal in the form of the user device 10 (see FIG. 1), the output display 90 (see FIG. 1), or the reporting unit 104 (see FIG. 1), but the graphical user interface 200 may be presented on another type of terminal or another device.

The graphical user interface 200 includes several different fields thereon, with each of the fields providing information regarding the conditions of a laboratory. The graphical user interface 200 includes a field 204 in the form of a pictorial representation. Field 204 provides information regarding a laboratory index in the form of a laboratory index that provides an assessment of the laboratory safety within the laboratory. The laboratory index may provide a metric representative of the functioning of the laboratory as a whole or for certain devices or aspects of the laboratory. Where this is the case, the laboratory index may take one or more of the following parameters into account including, but not limited to, temperature, lighting levels, sash position, fume hood face velocities, fume hood CFM, room air changes per hour (ACH), volatile organic chemicals (VOC), carbon dioxide (CO2), occupancy, chemicals, other airborne hazards, radioisotopes, maintenance of variable air volume (VAV) systems, filter management, flammability, safety training schedules, skill level of occupants, cleanliness and housekeeping, Standard Operating Procedure (SOP) program, and computational fluid dynamics (CFD) room modeling. In some embodiments, the laboratory index calculation may be dependent upon the field or the particular use for the laboratory, and features that are considered to be positive for some fields or uses may be negative for other fields or other uses. Thus, the system may beneficially be tailored to the user's particular use case, making the systems improvements over other one-size-fits-all solutions.

The Scientific Equipment Furniture Association (SEFA) has published a document in their standards “Selection and Management of Exposure Control Devices in Laboratories.” This document reviews the types of ventilated devices, applications for ventilated devices, and selection and responsibilities for the safety of these devices. Risk and performance are most important. Various parameters discussed in this SEFA document may be considered in determining laboratory indexes, and the material from this SEFA document is hereby incorporated by reference herein for all purposes.

For example, a laboratory index may be provided related to the conditions in a fume hood, and the laboratory index may be determined based on sensor data or other data related to fume hood velocity, differential pressure, gas levels, etc. However, laboratory indexes may be used for other applications. The field 204 indicates that the laboratory index is about 90%.

The graphical user interface 200 also includes a field 206 in the form of a pictorial representation. Field 206 provides information regarding a laboratory index in the form of a laboratory comfort index that provides an assessment of comfort levels within the laboratory. The laboratory comfort index may be calculated based on data for parameters such as temperature, humidity, and lighting, ensuring that the laboratory environment is safe and comfortable for personnel. The field 206 indicates that the laboratory comfort index is about 55%.

In some embodiments, the laboratory comfort index, laboratory safety index, and other laboratory indexes and parameters may be determined continuously at regular intervals so that it is effectively determined in real-time. For example, some of the laboratory indexes may be determined at least once an hour, at least once every 30 minutes, at least once every 15 minutes, at least once every 10 minutes, at least once every 5 minutes, at least once every 2 minutes, at least once every minute, at least once every 30 seconds, or at least once every 10 seconds. The laboratory indexes may be determined at different frequency levels relative to each other. For example, one laboratory index (e.g., the laboratory comfort index) may be determined at least once every 5 minutes while another laboratory index (e.g., the laboratory safety index) may be determined at least once every minute.

Continuous monitoring for known variables and laboratory indexes and displaying results in real-time may help to reduce the risk of working in a laboratory and may improve overall safety. Realtime monitoring of critical parameters using the sensors and devices 108A-108K may provide real-time data on critical parameters such as temperature, humidity, and air quality, enabling corrective actions to be taken quickly. By continuously monitoring and analyzing parameters regarding the laboratory and devices within the laboratory, areas for improvement may be identified and the performance of the laboratory and devices therein may be optimized over time.

The graphical user interface 200 also includes a field 208. Field 208 is a text field providing information regarding the time and date. In some embodiments, field 208 may be selected to provide more detailed information such as a calendar or a time stated that includes a number of seconds. A real-time clock may be provided in a terminal or another device within systems described herein, and this clock may have a night setback in some embodiments. The field 208 may be populated based on data from the real-time clock.

The graphical user interface 200 also includes a field 210 provided in the form of a selectable settings button. In some embodiments, field 210 may be selected to provide more detailed information regarding settings for the system. Selection of field 210 may allow the user to adjust certain acceptable ranges for laboratory indexes and/or other sensor data within the laboratory, to adjust the operation of certain devices within the laboratory (e.g., to make temperature controls less stringent when the laboratory is not in use, to adjust power levels for devices, to adjust airflow within the laboratory or devices therein, etc.). The field 210 may be configured to be selected in some embodiments so that the user can set time periods when certain devices (e.g., the terminal itself) are turned off, so that devices are turned off after being inactive for a time interval (e.g., 5 minutes, 30 minutes, etc.), etc. Selection of the field 210 may also enable presentation of a screen where alert settings and other notification settings may be adjusted by the user.

The graphical user interface 200 also includes a field 212 provided in the form of a selectable power button. In some embodiments, field 212 may be selected to turn the terminal off. In some embodiments, selection of the field 212 may cause other devices and/or sensors within the laboratory to be turned off.

The graphical user interface 200 also includes a field 214 provided in the form of a selectable button. The field 214 may be selected to access information related to one or more cameras within a laboratory. In some embodiments, selection of the field 214 may cause a video feed or still images from camera(s) to be presented. In some embodiments, selection of the field 214 may allow for details regarding the camera(s) to be presented (e.g., type of cameras, number of cameras, information related to the devices that cameras are monitoring, etc.).

The graphical user interface 200 also includes a field 216 provided in the form of a selectable button. The field 216 may be selected to access information related to one or more fume hoods within a laboratory. For example, selection of the field 216 may be configured to show sensor data related to conditions within the fume hood such as volumetric flow rate, flow speed, humidity, temperature, pressure, etc. However, selection of the field 216 may be configured to present information related to other aspects of fume hood(s).

The graphical user interface 200 also includes a field 218 provided in the form of a selectable button, with a graphical representation presented on the selectable button. The field 218 includes a graphical representation of a laboratory index related to volatile organic compound content within a laboratory or a device within the laboratory (e.g., within a fume hood), with the laboratory index provided in the form of a slider. The graphical representation in the field 218 also indicates whether or not the laboratory index related to the volatile organic compound content is within an acceptable range. In some embodiments, field 218 may be selectable to provide more detailed information related to the volatile organic compound content, and this information may be broken down with specific sensor data regarding important types of volatile organic compounds and acceptable ranges for each type. In other embodiments, other graphical representations may be provided in the graphical user interface 200 related to carbon dioxide levels or other levels, with these levels or a laboratory index associated therewith provided in the form of a slider.

The graphical user interface 200 also includes a field 220 in the form of a selectable button with a text presented thereon. The text includes information related to the electrical load, the power factor, the energy usage in a given month, and the energy usage in a given year. The texts provide information for a laboratory as a whole. However, in some embodiments, the field 220 may be selected to provide more detailed information, and this detailed information may include energy usage information related to specific devices in the laboratory. In some embodiments, selection of the field 220 may cause recommended actions to be presented to the user that improve energy usage.

The graphical user interface 200 also includes a field 222 in the form of a selectable button with text presented thereon. The text includes details regarding alarms set within the laboratory, with this alarm data being included in historical data that may be stored in memory device(s). In some embodiments, the field 222 may be presented in another color or may be configured to flash where an alarm is actively going off. The text on the field 222 also includes a number of alarms that are currently set up. However, in some embodiments, the text on the field 222 may indicate the number of alarms that are actively going off. The field 222 may be selected in some embodiments to provide more detailed information related to alarms. The alarms may be indicative of conditions within a laboratory falling outside of a range. In some embodiments, selection of the field 222 may cause presentation of a screen where a user may adjust the alarms, turn alarms on or off, adjust the acceptable ranges for which an alarm does not go off, and/or to review historical data regarding alarms that have been triggered in the laboratory.

The graphical user interface 200 also includes a field 224 in the form of a selectable button with text thereon related to gas consumption. The text includes details regarding usage of specific gases such as nitrogen, ammonia, and hydrogen within the laboratory. The graphical user interface 200 also includes a field 226 in the form of a selectable button with text thereon related to air supply and exhaust data. Both of these fields 224, 226 may be selectable to view more detailed information and/or to adjust details regarding gas consumption and airflow, and this detailed information may include specific data regarding gas consumption and/or airflow for specific devices within the laboratory.

The graphical user interface 200 also includes a field 228 with a graphical representation with information related to pressure, a field 232 with a graphical representation with information related to humidity, and a field 234 with a graphical representation with information related to temperature. The fields 228, 232, 234 may be configured to present data for the laboratory as a whole, but the fields 228, 232, 234 may be configured to present data for a specific device within the laboratory in other embodiments. For example, the fields 228, 232, 234 may be configured to present information related to a specific fume hood. In some embodiments, some or all of the fields 228, 232, 234 may be configured to be selectable so that more detailed information may be presented. For the fields 204, 206, 228, 232, 234, the outer rings within graphical representations indicate the actual values, and the inner rings within graphical representations are provided in a particular color (e.g., green, yellow, red, etc.) to indicate whether the actual values are good or bad.

In some embodiments, selection of a field may allow detailed information of a certain parameter overtime to be presented. For example, selection of the field 232 may show the humidity levels within the laboratory over time. Alternatively, selection of a field may allow a detailed comparison to be provided for the laboratory relative to other laboratories or for devices or parameters within one laboratory to be compared to devices or parameters for another laboratory.

The graphical user interface 200 also includes a field 230 in the form of a text field. The text field may be configured to provide details regarding the status of the laboratory or devices therein and details regarding alarms. If an alarm is actively going off, detailed information related to the alarm may be presented in the field 230, and the field 230 or the graphical user interface 200 as a whole may be presented in a different color or may be configured to flash in intervals to get the user's attention. Terminals may also include buzzers, speakers, or other devices configured to provide audible indications of an alarm. The field 230 may also include detailed information on how to best address the alarm (e.g., turning off power to a device, changing the airflow level within a device, etc.).

The graphical user interface 200 also includes a field 236 with a selectable button allowing an exhaust status to be seen and adjusted (e.g., to selectively permit or prohibit exhaust air flow), and the graphical user interface 200 also includes a field 238 with a selectable button allowing a heater to be turned on or turned off. However, in some embodiments, the field 236, 238 may be replaced with sliders or other interface elements to enable the exhaust levels and heater levels to be adjusted to certain levels.

FIG. 2B illustrates an example graphical user interface 200A similar to the graphical user interface 200 of FIG. 2A where a pop-up window 240 is presented with an indication of a recommended corrective action. The pop-up window 240 provides information on a corrective action aimed at improving energy consumption in the laboratory. The pop-up window 240 states that it is recommended to expand the permitted temperature ranges for the laboratory during times when the laboratory is not in use, and the pop-up window 240 prompts the user to answer whether or not the user would like to proceed with the recommended corrective action. If the user selects yes, then the corrective action may be taken. However, if the user does not make a selection or if the user selects no, then the corrective action may not be taken. The corrective action indicated in the pop-up window 240 is merely one example of a corrective action that may be taken, and other alternative corrective actions may be taken. While the pop-up window 240 is used in the embodiment illustrated in FIG. 2B to present information on the proposed corrective action, this information may instead by presented in another field in the graphical user interface 200A (e.g., at field 230 of the graphical user interface 200 of FIG. 2A). Additionally, in other embodiments, the system may simply take the corrective action automatically without waiting for authorization from the user in some embodiments. This may be done, for example, in situations where there is an imminent safety threat within a laboratory or a threat of damage to equipment in the laboratory.

In some embodiments, an alert may be generated at a terminal. The alert may be generated upon the laboratory index falling outside of a range in some embodiments. The range may be specified by a user, with the user inputting a specified range that the laboratory index should remain in, and the alert may be generated when the laboratory index falls outside of this specified range. However, in other embodiments, the alert may be generated based on ranges that do not require input of the user. For example, the alert may be generated based on a determination that the laboratory index falls outside of an acceptable range, with the acceptable range being determined based on historical data received from the laboratory device, the laboratory, other laboratory devices, or other laboratories. For example, an acceptable range may be within one standard deviation of the average laboratory index for all laboratories for which historical data is available, and an alert may be generated when the laboratory index in a user's laboratory falls outside of this acceptable range. Alternatively, the acceptable range may be determined based on historical data received from other laboratory devices or laboratories when failures or malfunctions occurred, and alerts may be provided to avoid similar failures or malfunctions in the user's laboratory. Machine learning models may also determine alerts as well as described herein.

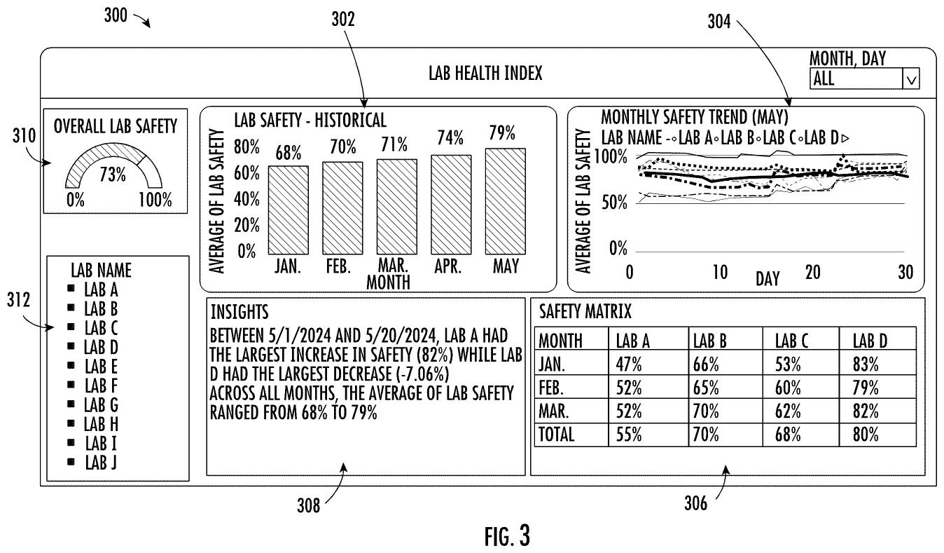

FIG. 3 illustrates an example graphical user interface 300 that may be presented on a terminal with various fields included showing safety index information for different labs over time. The graphical user interface 300 is configured to present data related to the laboratory index over time. The graphical user interface 300 is also configured to present a comparison of the laboratory index relative to laboratory indexes for other laboratories.

The graphical user interface 300 includes a field 302 including a graphical representation of a laboratory index over time. The graphical representation is provided in the form of a bar graph showing the laboratory index over the course of five months. However, in other embodiments, the graphical representation may be presented differently. The laboratory index referenced on the graphical user interface 300 is a laboratory safety index, but other types of indexes may be presented on other graphical user interfaces 300. In some embodiments, the laboratory safety index may be stated in terms of a percentage. In some embodiments, a laboratory safety index may instead be stated in terms of a laboratory risk index. Where this is done, the laboratory index may be inverted so that the entire representation of safety in 0 to 100% is inversed to 100% to 0% of risk, though the calculation remains the same. For example, a laboratory safety index of 80% may correspond to a laboratory risk index of 20%, and a laboratory safety index of 60% may correspond to a laboratory risk index of 40%.

The graphical user interface 300 also includes a field 304. The field 304 includes a graphical representation in the form of a line graph, with the line graph illustrating the laboratory safety index for various labs over the course of a month. This allows a visualization of how the laboratory safety index for one laboratory compares to others.

The graphical user interface 300 also includes a field 306. Field 306 illustrates a table presenting a safety matrix, with the safety matrix including laboratory safety indexes for different laboratories in particular months and a total laboratory index for all included months. While three months and four laboratories are included in the safety matrix, a different number of months and a different number of laboratories may be included in the safety matrix in other embodiments.

The graphical user interface 300 also includes a field 308 that is provided in the form of a text field. The field 308 presents insights regarding the operation of the laboratory and the laboratory safety index over the relevant time period.

The graphical user interface 300 also includes a field 310 with a graphical representation of the overall laboratory safety index over the course of the relevant time period. The field 310 indicates that the laboratory safety index is about 73%, and this number may be the average laboratory safety index in the relevant time period.

The graphical user interface 300 also includes a field 312 with a plurality of toggle buttons. The field 312 may enable the user to select which laboratories that the user wishes to have information presented on in the graphical user interface 300, and the field 312 may enable the user to omit information related to certain laboratories.

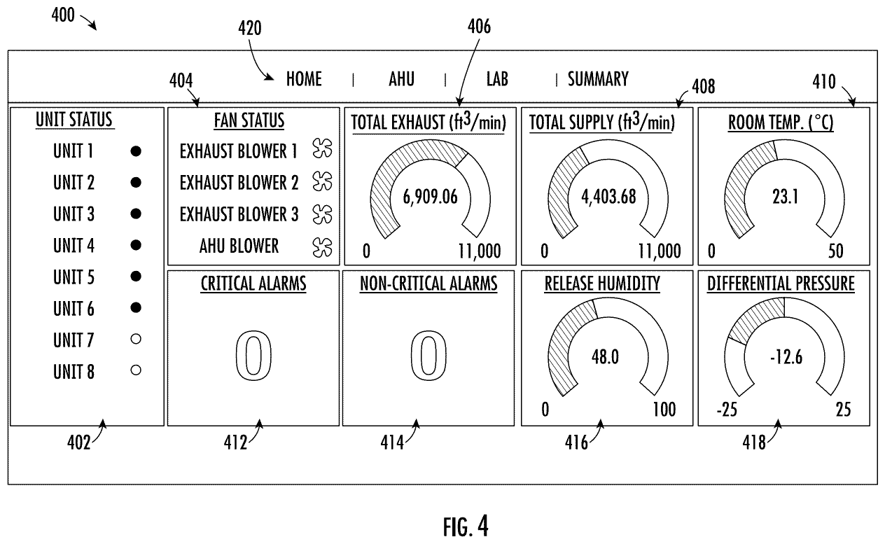

FIG. 4 illustrates an example graphical user interface 400 that may be presented on a terminal with various fields included showing values for different parameters related to HVAC systems within a laboratory. The graphical user interface 400 includes a field 402 that is configured to present a status of various units, and these units may be outdoor units in some embodiments (e.g., outdoor HVAC systems). The field 402 indicates that units 1 through 6 are active with the circles being colored, and the field 402 indicates that the units 7 and 8 are not active with the circles not being colored.

The graphical user interface 400 also includes a field 404. The field 404 is configured to present the status of various fans. The field 404 indicates that exhaust blowers 1 through 3 are active and that the air handling unit (AHU) blower is also active, with the symbols adjacent to the text providing this indication. Where a blower is not active, a symbol may not be presented or a different symbol may be presented.

The graphical user interface 400 also includes a field 406 providing a graphical representation of the total air exhaust for HVAC systems in terms of cubic feet per minute. The graphical user interface 400 also includes a field 408 providing a graphical representation of the total air supply for HVAC systems in terms of cubic feet per minute. Fields 406, 408 present total air exhaust and total air supply for all HVAC systems associated with the laboratory, but the field 406 may instead present air exhaust and air supply for only a subset of the HVAC systems in some embodiments.

The graphical user interface 400 includes a field 410 providing a graphical representation of the room temperature in a laboratory, the graphical user interface 400 includes a field 416 providing a graphical representation of the relative humidity in a laboratory, and the graphical user interface 400 includes a field 418 providing a graphical representation of the differential pressure in a laboratory.

The graphical user interface 400 also includes a fields 412, 414, with these fields being provided in the form of text fields. The field 412 provides a number of critical alarms occurring in the laboratory, and the field 414 provides a number of non-critical alarms occurring in the laboratory. The fields 412, 414 provide alarm information within a certain time interval (e.g., within the past month), but the fields 412, 414 may provide alarm information since the initial use of the system. The graphical user interface 400 also includes a menu element 420 allowing the user to select different screens for presentation.

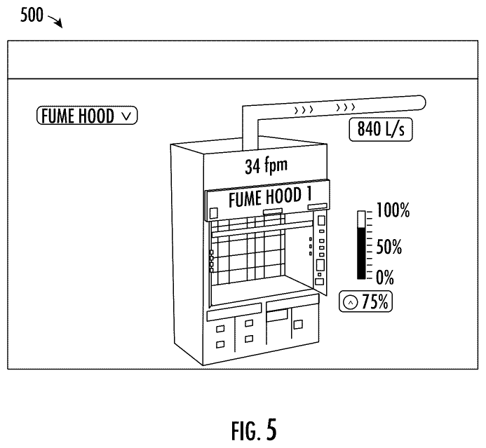

FIG. 5 illustrates an example graphical user interface 500 that may be presented on a terminal with a pictorial representation of a fume hood illustrated alongside indications of different parameters related to the operation of the fume hood. The graphical user interface 500 includes indications of the flow speed in feet per minute, a volumetric flow rate in liters per second, and a relative humidity. However, other information may be presented in the graphical user interface 500 as well. Additional fume hoods and other components may be represented in graphical user interfaces in other embodiments, and the positioning of various components within a laboratory may be presented on the graphical user interface 500 in some embodiments.

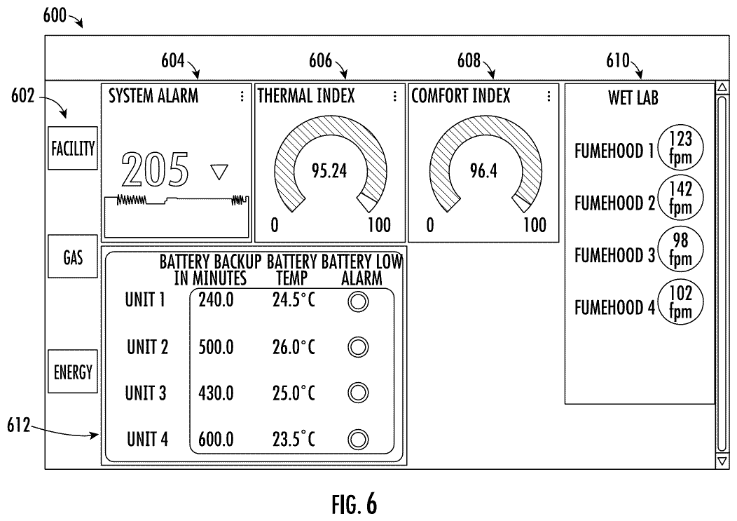

FIG. 6 illustrates another example graphical user interface 600 that may be presented on a terminal with various fields included showing values for different parameters related to the operation of a laboratory. The graphical user interface 600 includes a menu element 602 with selectable buttons allowing different laboratory indexes to be presented related to a facility, gas usage, and energy usage.

The graphical user interface 600 also includes fields 604, 606, 608. Field 604 includes a text field with material on the number of system alarms over a certain time period. Field 606 provides a graphical representation of a laboratory index related to thermal systems within a laboratory, and field 608 includes a graphical representation of a laboratory index related to the general comfort level for users in a laboratory. The graphical user interface 600 includes a field 610 with text fields regarding the flow velocities within various fume hoods. Additionally, the graphical user interface 600 includes a field 612 including a table with information related to battery levels and battery temperatures for various units (e.g., fume hoods).

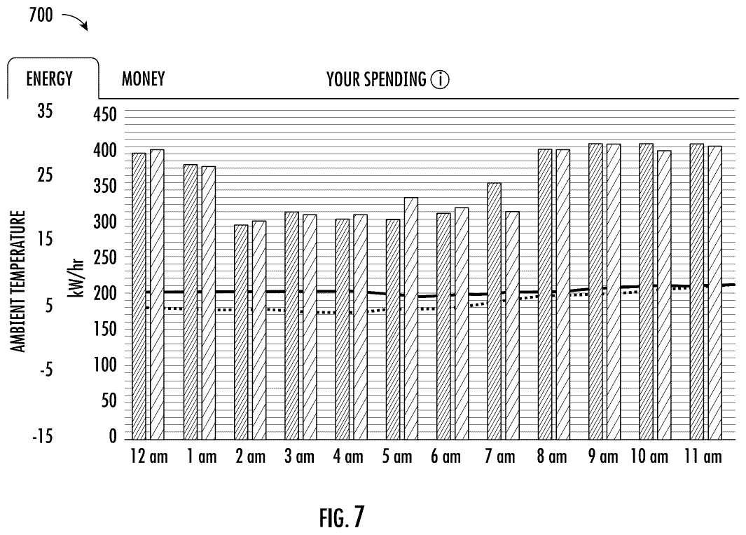

FIG. 7 illustrates a plot 700 that may be presented on a graphical user interface with information regarding energy consumption within a laboratory over time. In some embodiments, the plot 700 may be presented upon selection of the energy button in the menu element 602 illustrated in FIG. 6. The plot 700 presents the average energy usage for each hour from 12 AM to 11 AM in terms of kilowatts per hour, and the plot also illustrates the average ambient temperature for each hour during the same time interval in degrees Celsius. While the energy tab is selected in FIG. 7 to cause the plot 700 to be presented with energy consumption data, another similar plot may be presented that is stated in terms of the amount of money expended on energy per hour instead of kilowatts per hour. In some embodiments, recommended changes may be presented to the user, and the impact of the recommended changes on energy consumption and money spend may be illustrated in a plot similar to plot 700.

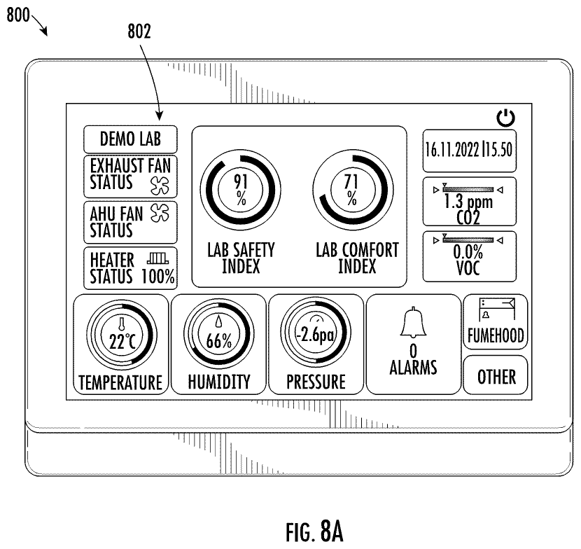

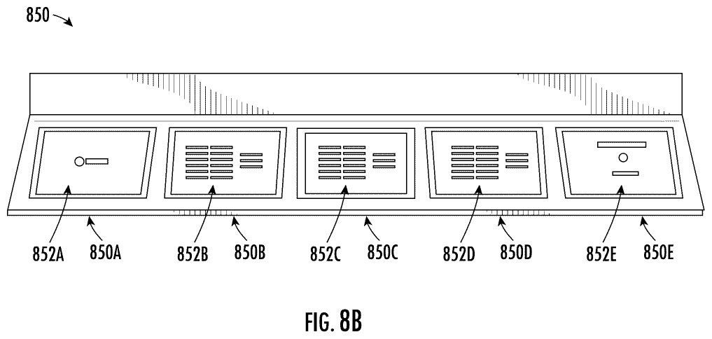

FIG. 8A is a front view illustrating an example terminal 800 having a graphical user interface 802 presented on the screen of the terminal. The terminal 800 is configured to be mounted in a laboratory at a wall or at another location. However, graphical user interfaces may be presented on other types of terminals that are not mounted in a laboratory. For example, graphical user interfaces may be presented on other mobile devices such as cell phones, tablets, or computers. In some embodiments, the terminal 800 may be mounted at another location outside of a laboratory such as in a control room or in an office.

FIG. 8B is a front view illustrating an example multi-terminal device 850 comprising five different terminals, with each terminal providing information for a different laboratory. The multi-terminal device 850 is configured to be mounted in a laboratory at a wall or at another location. However, in some embodiments, the multi-terminal device 850 may be mounted at another location outside of a laboratory such as in a control room for several different laboratories or in an office. The multi-terminal device includes a first terminal 850A having a first screen 852A, a second terminal 850B having a second screen 852B, a third terminal 850C having a third screen 852C, a fourth terminal 850D having a fourth screen 852D, and a fifth terminal 850E having a fifth screen 852E.

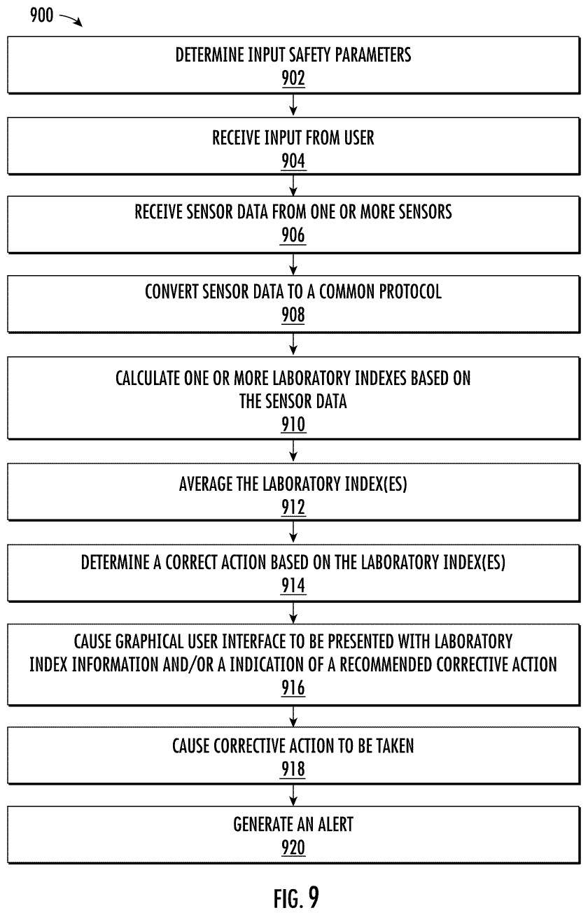

An example method 900 for determining and using a laboratory index is illustrated in the flow chart of FIG. 9. At operation 902, input parameters may be determined, and these input parameters may be related to safety, comfort levels, or other parameters within a laboratory. The input parameters may be determined based on the type of laboratory index that is being determined or the type of use that the laboratory is being used for.

At operation 904, input may be received from a user. The input received from the user may be provided in the form of set points, maximum values, minimum values, or a differential for one or more safety parameters. However, in some embodiments, these values and acceptable ranges for sensor data and/or laboratory indexes may not be determined by a user, and the acceptable ranges may instead be determined by a machine learning unit or another approach. For example, acceptable ranges may be determined based on historical data from other laboratories or historical data from the user's laboratory.

At operation 906, sensor data is received from one or more sensors. The sensor data may be related to the operation of laboratory devices within the laboratory or to other conditions within the laboratory.

At operation 908, sensor data may be converted to a common communication protocol. For example, the sensor data may initially be received in several different communication protocols, and the at least some of the sensor data may be converted to a common communication protocol so that sensor data used to calculate any laboratory index(es) possesses the same common communication protocol.

At operation 910, one or more laboratory indexes may be calculated based on the sensor data. A laboratory index may be calculated that considers all sensor data and that gives a comprehensive assessment of a laboratory's current state. Alternatively, a laboratory index may only consider sensor data related to a particular aspect of the laboratory to give an assessment on that aspect of the laboratory. For example, the laboratory index may consider sensor data related to the functioning of fume hoods within a laboratory, and the laboratory index may be indicative of the condition of fume hoods in the laboratory.

In some embodiments, the laboratory index(es) may be determined continuously at regular intervals. For example, some of the laboratory indexes may be determined at least once an hour, at least once every 30 minutes, at least once every 15 minutes, at least once every 10 minutes, at least once every 5 minutes, at least once every 2 minutes, at least once every minute, at least once every 30 seconds, or at least once every 10 seconds.

In some embodiments, the laboratory index may be determined using a machine learning model, and the machine learning model may be configured to utilize sensor data as input data for the model. The machine learning models may provide enhanced accuracy in some embodiments relative to other algorithmic approaches or approaches relying upon user input. A machine learning model may be configured to provide an output in the form of the laboratory index, but the model may be configured to provide an output in the form of a corrective action or an alert in some embodiments. In some embodiments, the model may be trained based on historical data regarding other laboratory devices that are identical to the laboratory devices within the laboratory that is under evaluation. Some or all of the other laboratory devices may be located in other laboratories. The ability to train the model using data from other laboratory devices in other laboratories may provide a large amount of training data, thereby allowing models to be determined with increased accuracy. Additionally, the data obtained from other laboratory devices in other laboratories may be aggregated and/or anonymized before being used to train any machine learning model.

At operation 912, the laboratory indexes may be averaged. At operation 914, a corrective action is determined based on the one or more laboratory indexes. In some embodiments, the corrective action may be determined based on the average of the laboratory indexes that is obtained at operation 912.

At operation 916, presentation of the graphical user interface is caused with the graphical user interface including fields comprising data related to a laboratory index and/or an indication of a recommended corrective action. Presentation of the graphical user interface may be caused on a user device 10, on an output display 90, on a reporting unit 104, or on a display of another device. In some embodiments, the indication of a recommended corrective action may be presented to the user on the graphical user interface in a way that allows the user to quickly make a selection regarding whether or not the user would like to implement the recommended corrective action.

At operation 918, a corrective action is caused. In some embodiments, the corrective action may be automatically taken without any action required from a user. However, in other embodiments, the corrective action may be taken only after authorization from a user. The corrective action may be caused to improve the conditions within the laboratory in some way.

At operation 920, an alert is generated. This alert may be generated upon the laboratory index falling outside of a range. The range may be specified by a user, with the user inputting a specified range that the laboratory index should remain in, and the alert may be generated when the laboratory index falls outside of this specified range. However, in other embodiments, the alert may be generated based on ranges that do not require input of the user. For example, the alert may be generated based on a determination that the laboratory index falls outside of an acceptable range, with the acceptable range being determined based on historical data received from other laboratory devices or other laboratories. For example, an acceptable range may be within one standard deviation of the average laboratory index for all laboratories for which historical data is available, and an alert may be generated when the laboratory index in a user's laboratory falls outside of this acceptable range. Alternatively, the acceptable range may be determined based on historical data received from other laboratory devices or laboratories when failures or malfunctions occurred, and alerts may be provided to avoid similar failures or malfunctions in the user's laboratory.

The method 900 is merely exemplary, and the method 900 may be modified in various ways without departing from the scope of the present invention. For example, the operations of the method 900 may be performed in different orders, and some of the operations of the method 900 may be performed simultaneously in some embodiments. Additionally, some of the operations may be omitted in some embodiments or additional operations may be added in other embodiments.

### CONCLUSION

Many modifications and other embodiments set forth herein will come to mind to one skilled in the art to which these embodiments pertain having the benefit of the teachings presented in the foregoing descriptions and the associated drawings. Therefore, it is to be understood that the embodiments are not to be limited to the specific embodiments disclosed and that modifications and other embodiments are intended to be included within the scope of the invention. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the invention. In this regard, for example, different combinations of elements and/or functions than those explicitly described above are also contemplated within the scope of the invention. Although specific terms are employed herein, they are used in a generic and descriptive sense only and not for purposes of limitation.

What is claimed is:

1. A system for determining and using a laboratory index for a laboratory, the system comprising:
a plurality of laboratory devices;
a plurality of sensors configured to obtain sensor data regarding operation of the plurality of laboratory devices or conditions in the laboratory;
a terminal comprising a screen;
at least one processor;
at least one memory device comprising computer readable code configured, when executed, to cause the at least one processor to:
receive the sensor data;
calculate the laboratory index based on the sensor data;
cause a graphical user interface to be presented on the screen with one or more fields comprising data related to the laboratory index.

2. The system of claim 1, further comprising:
an intake unit,
wherein the intake unit is configured to receive the sensor data from the plurality of sensors with the sensor data provided in a plurality of communication protocols, and wherein the intake unit is configured to convert at least some of the sensor data to a common communication protocol so that all of the sensor data is provided in the common communication protocol.

3. The system of claim 1, wherein the plurality of laboratory devices comprises at least one of a camera, a fume hood, an exhaust blower, a heater, a chiller, a pump, a valve, a laboratory display, a gas chamber or a gas valve, a HVAC filter, a scrubber pump, or a scrubber tank.

4. The system of claim 1, wherein the plurality of sensors comprises at least one of a carbon dioxide sensor, an airflow sensor, a temperature sensor, a humidity sensor, a pressure sensor, an occupancy sensor, a volatile organic compound sensor, a water level sensor, a pH meter, energy usage sensors, or an air quality sensor.

5. The system of claim 1, wherein the computer readable code is configured, when executed, to cause the at least one processor to:
determine a corrective action based on the laboratory index; and
cause an indication to be presented on the graphical user interface that recommends taking the corrective action or causes the corrective action to be automatically taken.

6. The system of claim 5, wherein the laboratory index is focused on energy consumption in the laboratory, and wherein the corrective action provides more efficient energy consumption in the laboratory.

7. The system of claim 1, further comprising:
a machine learning unit,
wherein the machine learning unit is configured to develop a model, wherein the model is configured to use the sensor data as an input to the model, and wherein the model is configured to provide an output in the form of the laboratory index, a corrective action, or an alert.

8. The system of claim 7, wherein the machine learning unit is configured to develop the model based on historical data regarding operation of one or more laboratory devices that are identical to the plurality of laboratory devices.

9. The system of claim 8, wherein a laboratory device of the one or more laboratory devices is located in another laboratory.

10. The system of claim 1, wherein the terminal is mounted in the laboratory.

11. The system of claim 1, wherein the terminal is a mobile device.

12. The system of claim 1, wherein the laboratory index is calculated at least once every five minutes.

13. The system of claim 1, wherein the laboratory index is indicative of a safety level or a comfort level for the laboratory or a laboratory device of the plurality of laboratory devices.

14. The system of claim 1, wherein the computer readable code is configured, when executed, to cause the at least one processor to:
generate an alert at the terminal upon the laboratory index falling outside of a range.

15. The system of claim 1, wherein the graphical user interface is configured to present data related to the laboratory index over time.

16. The system of claim 15, wherein the graphical user interface is configured to present a comparison of the laboratory index relative to one or more additional laboratory indexes for other laboratories.

17. A method for determining and using a laboratory index for a laboratory, the method comprising:
receiving sensor data from a plurality of sensors regarding operation of laboratory devices within the laboratory or conditions in the laboratory;
calculating a laboratory index based on the sensor data; and
causing a graphical user interface to be presented on a screen of a terminal, the graphical user interface comprising one or more fields comprising data related to the laboratory index.

18. The method of claim 17, wherein the sensor data is received from the plurality of sensors in a plurality of communication protocols, and wherein at least some of the sensor data is converted to a common communication protocol so that all of the sensor data used to calculate the laboratory index is provided in the common communication protocol.

19. The method of claim 18, further comprising:
determining a corrective action based on the laboratory index; and
causing an indication to be presented on the graphical user interface that recommends taking the corrective action or causes the corrective action to be automatically taken.

20. The method of claim 19, wherein the laboratory index is determined using a machine learning model with the machine learning model configured to utilize the sensor data as input data.
